(19) United States
(12) Patent Application Publication
(10) Pub. No.: US 2026/0153407 A1
(43) Pub. Date: Jun. 4, 2026

(54) SINGLE-ENDED MEASUREMENT OF THE SPECTRAL TRANSMISSION RESPONSE OF AN OPTICAL DEVICE UNDER TEST

(71) Applicant: EXFO Inc., Quebec (CA)

(72) Inventors: Yves BRETON, Quebec (CA); Hongxin CHEN, Montreal (CA); Vincent CHOUINARD, Quebec (CA)

(21) Appl. No.: 19/398,784

(22) Filed: Nov. 24, 2025

Related U.S. Application Data
(60) Provisional application No. 63/726,356, filed on Nov. 29, 2024.
(60) Provisional application No. 63/870,543, filed on Aug. 26, 2025.

(51) Int. Cl. G01M 11/00

(52) U.S. Cl. CPC G01M 11/3127; G01M 11/3154

(57) ABSTRACT

There is provided a method for measuring the spectral transmission response of a DUT using a multi-wavelength Optical Time Domain Reflectometer (OTDR) which allows performing OTDR measurements across a spectral range of interest. The OTDR targets a single reflective OTDR event along the OTDR trace, e.g., a mirror, a non-angled polished (UPC) connector or any other reflective surface located at the remote end of the DUT, which reflectance peak in combination with a reference measurement allows to perform single-end measurements of the transmission response. The process is repeated at various wavelengths to obtain a spectral transmission response of the DUT.

### TECHNICAL FIELD

The present description generally relates to optical insertion loss measurement, and more particularly to spectrally resolved optical insertion loss measurement.

### BACKGROUND

Characterization of Passive Optical Devices (PODs) generally involves a series of measurements to evaluate how the device performs under various optical conditions. It typically involves Insertion Loss (IL), Optical Return Loss (ORL), Polarization Dependent Loss (PDL), Chromatic Dispersion (CD), etc. In many cases, it is required to measure the spectral transmission response or, in other words, the spectrally resolved IL profile of the passive optical device.

Optical return loss is a measure of how much light is reflected back toward the source from the component, whereas optical transmission loss is a measure of the amount of signal power loss as light passes through the component, which is caused by absorption, scattering, and imperfect coupling inside the component.

Conventional methods for measuring the spectrally resolved IL profile of passive optical devices use a forward pass-through configuration, i.e., a two-ended measurement method wherein an optical test signal is injected into the passive optical device under test at one, and the optical test signal received at the other end is detected to measure the passive optical device transmission response. This may be accomplished using one of the following two methods:

In the first measurement method, a tunable laser source is used to generate the test signal and is swept across the test bandwidth while the output power is measured at the other end using an optical power meter (see Chapter 9, Section 9.7, “Wavelength-Dependent Loss Measurements Using A Tunable Laser”, pp. 359-366 of Hewlett-Packard professional book “Fiber Optic Test and Measurement” by Dennis Derickson, Prentice Hall PTR, 1998). The power at the output of the device under test is compared to the input power to obtain the transmission response as a function of the wavelength.

The second measurement method usually requires a broadband source and an Optical Spectrum Analyzer (OSA) (see Chapter 9, Section 9.8, “Wavelength-Dependent Loss Measurements Using A Broadband Source”, pp. 368-381 of Hewlett-Packard professional book “Fiber Optic Test and Measurement” by Dennis Derickson, Prentice Hall PTR, 1998). A broadband power spectrum is measured and the transmission response as a function of wavelength is obtained by comparing the power spectrum measured at the output of the device under test to the input power spectrum.

Both methods are two-ended and require the connection of a light source (tunable laser source or broadband source) at one end and a measurement device (an optical power meter or an OSA) at the other end of the device under test. However, two-ended measurements may sometimes be impossible because the output of the device under test is inaccessible or does not even exist.

Conventional methods for characterizing passive optical devices also include single-ended optical return loss measurements. An optical test signal is injected into the passive optical device under test at one end via an optical coupler. The injected optical signal is monitored at one port of the optical coupler and optical signal returning from the passive optical device is detected at another port of the optical coupler. A tunable laser source is used to generate the optical test signal and is swept across the test bandwidth, in order to obtain the optical return loss response of the passive optical device (see Couny, “Return loss referencing using the CTP10 test platform”, app note 381, EXFO, 2023).

However, such single-ended method does not provide the spectral transmission response of the passible optical device. Instead, it provides the optical return loss, which is different from the spectral transmission loss.

There therefore remains a need for alternative methods for measuring the spectral transmission response of passive optical devices.

### SUMMARY

There is herein described a single-ended measurement method for measuring the spectral transmission response of an optical Device Under Test (DUT).

There is provided a method for measuring the spectral transmission response of a DUT using a multi-wavelength Optical Time Domain Reflectometer (OTDR) which allows performing OTDR measurements across a spectral range of interest. The OTDR targets a single reflective OTDR event along the OTDR trace, e.g., a mirror, a non-angled polished (UPC) connector or any other reflective surface located at the remote end of the DUT, which reflectance peak in combination with a reference measurement allows to perform single-end measurements of the transmission response. The process is repeated at various wavelengths to obtain a spectral transmission response of the DUT.

Optical Time Domain Reflectometry (OTDR) has the advantage of allowing measurements to be made via a single end of an optical device under test. Single-end measurements can be of great advantage when two-ended measurements are impossible because the output of the DUT is inaccessible or does not even exist.

In some embodiments, the dynamic range/acquisition time of the measurement may be improved using a technique similar to correlation coded OTDR. In short, for each OTDR acquisition, instead of launching a single OTDR pulse at a time, a sequence of pulses is used (also referred to herein as a pulse train). A correlation method is then used to detect the sequence of pulses after a back-reflection from a reflective event at the remote end of the DUT, and extract the position and the reflection level of the reflective peak.

In accordance with one aspect, there is provided a method for measuring the spectral transmission response of an optical device under test, the method comprising:
performing a plurality of OTDR acquisitions from a proximal end of the device under test for a corresponding plurality of mutually-different wavelengths, wherein each OTDR acquisition is performed by propagating in the device under test, a pulsed test signal and detecting a corresponding return light signal from the device under test representing backscattered and reflected light as a function of distance in the device under test;
for each of the OTDR acquisitions, extracting a value of a reflection level of a reflective peak associated with a reflective surface at a remote end of the optical device under test; and
calculating values of a spectral transmission response associated with said device from the values of reflection level of the reflective peak as a function of said wavelengths, in combination with a reference measurement associated with a reference reflector.

In accordance with another aspect, there is provided a test system for measuring the spectral transmission response of an optical device under test, the OTDR system comprising:
an OTDR acquisition device connectable toward a proximal end of the device under test for performing a plurality of OTDR acquisitions for a corresponding plurality of mutually-different wavelengths, wherein each OTDR acquisition is performed by propagating in the device under test, a pulsed test signal and detecting a corresponding return light signal from the device under test representing backscattered and reflected light as a function of distance in the device under test,
a reference device connectable to said OTDR acquisition device for performing a plurality of OTDR acquisitions toward said reference device, to obtain therefrom a reference measurement as a function of wavelengths across the spectral range of interest; and
a processing unit receiving the plurality of OTDR acquisitions and configured for:
   from the plurality of OTDR acquisitions, extracting values of a reflection level of a reflective peak associated with a reflective surface at a remote end of the optical device under test;
   from the plurality of OTDR acquisitions, extracting values of said reference measurement as a function of wavelengths; and
   calculating values of a spectral transmission response associated with said device from the values of reflection level of the reflective peak as a function of said wavelengths, in combination with the reference measurement associated with the reference device.

In some embodiments, the method or system may comprise one or more of the following features, considered alone or according to all technically possible combinations.

In some embodiments, said OTDR acquisition device comprises a tunable pulsed light source to perform said plurality of OTDR acquisitions at mutually-different wavelengths across a spectral range of interest.

In some embodiments, said performing a plurality of OTDR acquisitions comprises tuning said pulsed test signal across a spectral range of interest to obtain each of said corresponding plurality of mutually-different wavelengths.

In some embodiments, said test signal comprises a plurality of light pulses in accordance with a known sequence of pulses.

In some embodiments, said value of reflection level of the reflective peak is obtained by calculating a cross-correlation between the known sequence of pulses and the acquired return signal.

In some embodiments, said reflective surface comprises a highly reflective device connected to the remote end of the device under test. In some embodiments, said highly reflective device comprises an opened non-angled polished connector at the remote end of the device under test. In some embodiments, said reflective surface comprises a reflective surface part of the device under test.

In some embodiments, the method further comprises:
performing a plurality of OTDR acquisitions toward a reference reflector for said plurality of mutually-different wavelengths, wherein each OTDR acquisition is performed by propagating toward the reference reflector, a pulsed test signal and detecting a corresponding return light signal from the device under test;
for each of said OTDR acquisitions, extracting a value of a reflection level of the reference reflector;
obtaining values of said reference measurement from the values of reflection level of the reflective peak as a function of said wavelengths.

In some embodiments, the steps of performing an OTDR acquisition from a proximal end of the device under test and performing an OTDR acquisition toward a reference reflector are performed concurrently.

In some embodiments, said calculating values of a spectral transmission response accounts for a spectral reflection response of said reflective surface and a spectral reflection response of said reference reflector.

In some embodiments, the processing unit is further configured for: from the plurality of OTDR acquisitions, extracting values of said reference measurement as a function of wavelengths.

In some embodiments, the test system further comprises a coupling device connected to direct the pulsed test signal toward the reference device and the device under test either concurrently or in turn.

In some embodiments, the coupling device comprises a power coupler to direct the pulsed test signal toward the reference device and the device under test concurrently.

In some embodiments, the coupling device comprises an optical switch to direct the pulsed test signal toward the reference device or the device under test, in turn.

In some embodiments, the coupling device comprises a bypass optical switch to direct the pulsed test signal toward the reference device or the device under test in series with the reference device, in turn.

In this specification, the term “Passive Optical Device (POD)” or “device under test” is intended to encompass various types of devices under test or optical transmission media, including without limitation, optical fiber links, specialty optical fibers such as multi-core fibers and hollow core fibers, Fiber Bragg Gratings (FBGs), interleavers, optical couplers, wavelength division multiplexers (WDMs), optical filters, isolators, circulators, attenuators, optical fiber connectors, photonic integrated circuits (PIC), etc., which may or may not include optical fibers or other optical waveguides.

In this specification, unless otherwise mentioned, word modifiers such as “substantially” and “about” which modify a value, condition, relationship or characteristic of a feature or features of an embodiment, should be understood to mean that the value, condition, relationship or characteristic is defined to within tolerances that are acceptable for proper operation of this embodiment in the context of its intended application. In particular, the term “about” generally refers to a range of numbers that one skilled in the art would consider equivalent to the stated value (e.g., having the same or an equivalent function or result). In some instances, the term “about” may mean a variation of ±10% of the stated value. It is noted that all numeric values used herein are assumed to be modified by the term “about”, and that all conditions, relationships or characteristics used herein are assumed to be modified by the term “substantially”, unless stated otherwise. The term “between” is used herein to refer to a range of numbers or values defined by endpoints is intended to include both endpoints, unless stated otherwise.

In the present description, and unless stated otherwise, the terms “connected”, “coupled” and variants and derivatives thereof refer to any connection or coupling, either direct or indirect, between two or more elements. The connection or coupling between the elements may be mechanical, physical, operational, electrical or a combination thereof.

In the present description, the terms “light” and “optical” are used to refer to radiation in any appropriate region of the electromagnetic spectrum. More particularly, the terms “light” and “optical” are not limited to visible light, but can include, for example, the near infrared wavelength range, including the optical telecommunication transmission bands such as the Dense Wavelength-Division Multiplexing (DWDM) spectral range.

Further features and advantages of the present invention will become apparent to those of ordinary skill in the art upon reading the following description, taken in conjunction with the appended drawings.

The following description is provided to gain a comprehensive understanding of the methods, apparatus and/or systems described herein. Various changes, modifications, and equivalents of the methods, apparatuses and/or systems described herein will suggest themselves to those of ordinary skill in the art. Description of well-known functions and structures may be omitted to enhance clarity and conciseness.

Although some features may be described with respect to individual exemplary embodiments, aspects need not be limited thereto such that features from one or more exemplary embodiments may be combined with other features from one or more other exemplary embodiments.

### BRIEF DESCRIPTION OF THE DRAWINGS

FIG. 1 illustrates a test configuration for measuring the spectral transmission response of an optical Device Under Test (DUT), in accordance with one embodiment and comprises FIG. 1A and FIG. 1B which are schematics where FIG. 1A illustrates a reference measurement step and FIG. 1B illustrates a DUT measurement step.

FIG. 2 is a schematic which illustrates a test configuration for measuring the spectral transmission response of a DUT, in accordance with another embodiment allowing the reference measurement step and the DUT measurement step to be performed concurrently.

FIG. 3 is a schematic which illustrates a test configuration for measuring the spectral transmission response of a DUT, in accordance with yet another embodiment which allows the reference measurement step and the DUT measurement step to be performed concurrently and wherein the reference device is integrated in the test instrument.

FIG. 4 illustrates a test configuration for measuring the spectral transmission response of a DUT, in accordance with yet another embodiment wherein the reference device is integrated in the test instrument via a bypass optical switch, and comprises FIG. 4A and FIG. 4B which are schematics where FIG. 4A illustrates a reference measurement step and FIG. 4B illustrates a DUT measurement step.

FIG. 5A is a block diagram illustrating an OTDR device adapted to measure the spectral transmission response of a DUT, in accordance with one embodiment employing a tunable laser source.

FIG. 5B is a block diagram illustrating an OTDR device adapted to measure the spectral transmission response of a DUT, in accordance with another embodiment employing a broadband light source.

FIG. 6 is a flow chart illustrating a method for measuring the spectral transmission response of a DUT, in accordance with one embodiment.

FIG. 7 is a flow chart illustrating the steps of extracting values of a spectral transmission response T(λ) and deriving the attenuation profile Atten(λ) associated with the DUT.

FIG. 8 is a graph showing exemplary measurement results as obtained on a DUT.

FIG. 9 is a block diagram illustrating an example architecture of an OTDR device as per FIG. 3 and FIG. 4.

FIG. 10 is a block diagram illustrating an example architecture of an OTDR acquisition device of the OTDR device of FIG. 9.

It will be noted that throughout the drawings, like features are identified by like reference numerals. In the following description, similar features in the drawings have been given similar reference numerals and, to not unduly encumber the figures, some elements may not be indicated on some figures if they were already identified in a preceding figure. It should be understood herein that elements of the drawings are not necessarily depicted to scale, since emphasis is placed upon clearly illustrating the elements and structures of the present embodiments. Some mechanical or other physical components may also be omitted in order to not encumber the figures.

Furthermore, throughout the drawings, and especially in block diagrams and flowcharts, dash lines are generally used to indicate that a component is intended to be optional.

### DETAILED DESCRIPTION

Optical Time-Domain Reflectometry (OTDR—also used to refer to the corresponding device) is widely employed for characterization of optical fiber links. OTDR is a diagnostic technique where a test signal in the form of light pulses is launched in the optical fiber link under test and the return light signal, arising from backscattering and reflections along the link, is detected and analyzed. The acquired power level of the return light signal as a function of time is referred to as an “OTDR trace” or a “reflectometric trace”, where the time scale is representative of distance between the OTDR acquisition device and a point along the fiber link. Herein, the process of launching a pulsed test signal and acquiring the return light signal to obtain therefrom an OTDR trace is referred to as an “OTDR acquisition”. Light acquisitions may be repeated with varied wavelengths of the pulsed test signal to produce a set of OTDR traces for a corresponding set of wavelengths. OTDR has the advantage of allowing measurements to be made via a single end an optical device under test.

In the following description, techniques that are generally known to the ones skilled in the art of OTDR measurement and OTDR trace processing and analysis will not be explained or detailed and in this respect, the reader is referred to available literature in the art. Such techniques that are considered to be known may include, e.g., signal processing methods for identifying and characterizing events from an OTDR trace. Similarly, an OTDR acquisition device is understood to comprise conventional optical hardware and electronics as known in the art for performing OTDR acquisitions on an optical fiber link.

One skilled in the art will readily understand that in the context of OTDR methods and systems, each light acquisition generally involves propagating a large number of substantially identical light pulses in the device under test and averaging the results. In this case, the result obtained from averaging will herein be referred to as an OTDR trace. It will also be understood that other factors may need to be controlled during light acquisitions or from one light acquisition to the next, such as gain settings, pulse power, etc., as is well known to those skilled in the art.

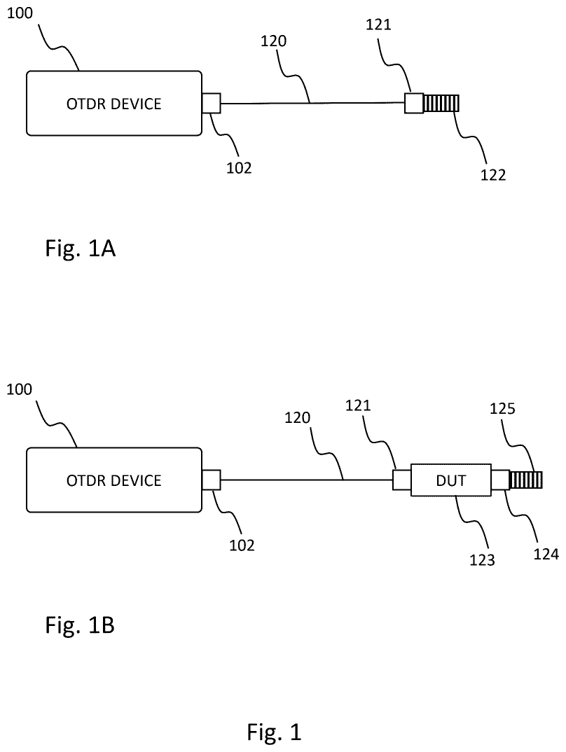

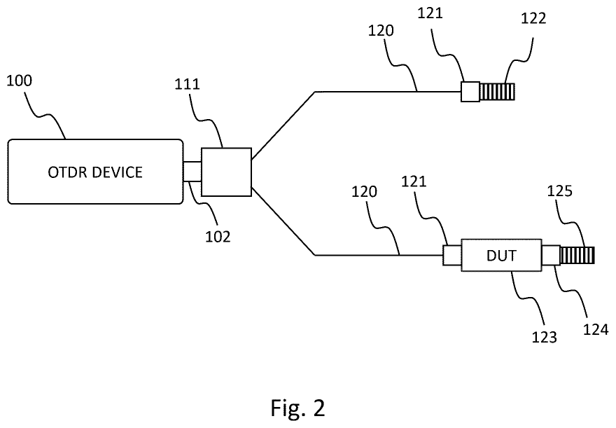

Now referring to the drawings, FIGS. 1 and 2 illustrate methods for measuring the spectral transmission response of an optical Device Under Test (DUT).

The method employs a multi-wavelength OTDR device 100 that is connected at a proximal end of the DUT 123 and which allows OTDR acquisitions to be performed at a plurality of mutually-different wavelengths across a spectral range of interest. The method then targets a single reflective event that is associated with a reflective surface 125 located at a remote end of the DUT 123. In the embodiments illustrated in FIGS. 1B and 2, the reflective surface may be provided in the form of a highly reflective device 125, such as a fiber mirror, connected to the remote end of the DUT 123. For example, a fiber mirror may comprise a coated fiber endface (having a reflectivity of, e.g., >98%) or a fiber loop mirror. In other embodiments (not illustrated), the reflective surface may be provided as an opened non-angled polished (UPC) connector present at the remote end of the DUT 123. In yet other embodiments (not illustrated), for example if no pass-through connector is accessible for connection at the remote end of the DUT 123, a reflective surface that is being part of the device under test, such as a natural reflection at the termination of the DUT 123, may be used as the reflective surface. For example, in the case of photonic integrated circuits (PIC), the spectral response of an optical feature of the PIC may be measured wherein an internal reflection of the optical feature (such as an end mirror of a laser cavity for example) is used as the reflective surface. In a typical application, the spectrally resolved optical reflection at the internal reflection may be measured to monitor and detect unwanted features, such as destructive and constructive interference for example.

The method involves a reference measurement (see FIG. 1A) which may be obtained by connecting a reference reflector 122 to the OTDR device 100, performing a plurality of OTDR acquisitions toward the reference reflector 122 for the plurality of wavelengths and extracting a value of a reflection level of the reference reflector 122 for each OTDR acquisition so as to obtain the reference measurement.

Referring to FIGS. 1A and 1B, in some embodiments, the reference step and the measurement step may be performed in turn, i.e., one after another, by connecting the reference reflector 122 to the OTDR device 100 for the reference step and disconnecting it to connect the DUT 123 for the measurement step.

FIG. 1A illustrates a reference step in which the reference reflector 122 is connected to the output port 102 of the OTDR device 100 via a reference cord 120 having an end connector 121 at its remote end. In some embodiments, the reference reflector 122 may be embodied as a highly reflective device, such as a fiber mirror obtained via a coated fiber endface (having a reflectivity of, e.g., >98%), a fiber loop mirror or any other reflective device that may be affixed to the reference cord 120 (with or without a connector 121). Such highly reflective reflector may be appropriate to obtain a high measurement dynamic range, for measuring long fiber lengths for example. In some embodiments (not illustrated), the highly reflective device may be provided as an opened (unmated) non-angled polished (UPC) connector (4% reflection), which reflectivity is lower but may be appropriate for shorter fiber lengths for example. In yet other embodiments, the reference reflector 122 may be embodied as a calibrated reflective device, tailored for the testing application such that its reflectivity corresponds to the expected reflectivity of the particular device under test. For example, such a calibrated reflective device may comprise an attenuation fiber combined with a fiber mirror.

FIG. 1B illustrates a measurement step in which the reference reflector 122 is disconnected from the end connector 121 to connect the DUT 123 between the end connector 121 and a reflective device 125 connected to the remote end of the DUT 123 via a connector 124. Like the reference reflector 122, in some embodiments, the reflective device 125 may be embodied as a highly reflective device, such as fiber mirror obtained via a coated fiber endface (having a reflectivity of, e.g., >98%) or a fiber loop mirror. In other embodiments (not illustrated), the reflective device 125 may be provided as an opened (unmated) non-angled polished (UPC) connector (4% reflection). Furthermore, in some embodiments, the reflective device 125 and the reference reflector 122 may be one and the same such that, for the measurement step, the DUT 123 is simply inserted between the end connector 121 and the reference reflector 122.

Referring to FIG. 2, in other embodiments, the reference step and the measurement step may be performed concurrently by connecting both the reference reflector 122 and the DUT 123 to the OTDR device 100 via a coupling device 111, wherein, in one embodiment, the coupling device 111 comprises a power coupler disposed at the output 102 of the OTDR device 100 to direct the OTDR pulsed test signal toward the reference device and the device under test concurrently. For example, a 50/50 power coupler may be used, wherein a common port of the power coupler 111 is connected at the output 102 of the OTDR device 100, and first and second split ports are respectively connected towards the reference device 122 and the device under test 123, such that the OTDR test signal received at the common port is split among the first and second ports, i.e., towards the reference device 122 and the device under test 123. In other embodiments, the coupling device 111 may comprise an optical switch which is used to replace the manual connections and disconnections of the embodiment of FIGS. 1A and 1B, the reference and measurement steps then being performed one after another via optical switching. For example, a common port of the optical switch 111 is connected at the output 102 of the OTDR device 100, and first and second switch ports are respectively connected towards the reference device 122 and the device under test 123, such that the OTDR test signal received at the common port can be switched to the first and the second ports in alternance, i.e., towards the reference device 122 and the device under test 123.

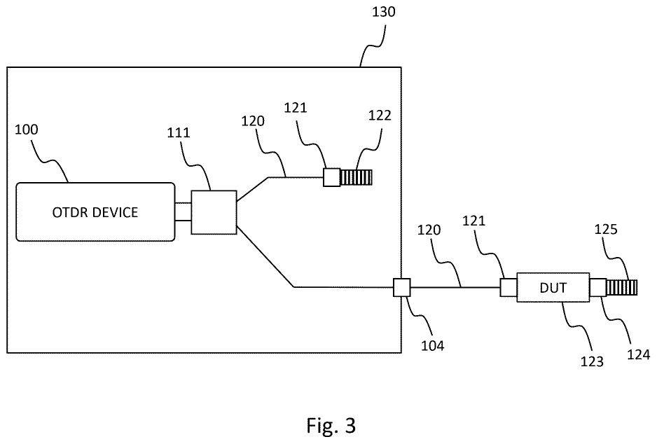

Referring to FIG. 3, in some embodiments, the coupling device 111 and the reference reflector 122 may be integrated directly into the OTDR test instrument 130. The second port of the coupling device 111 is internally coupled to the output port 104 of the OTDR test instrument 130 so as to allow connection of the DUT 123.

It is noted that the embodiments illustrated in FIGS. 1B, 2, and 3 employ a reflective device 125 that is connected to the remote end of the DUT 123. However, in some cases, no pass-through connector may be accessible for connection at the remote end of the DUT. It these cases, the presence of a reflective surface part of the device under test and located at or near its termination may be used in place of the reflective device 125.

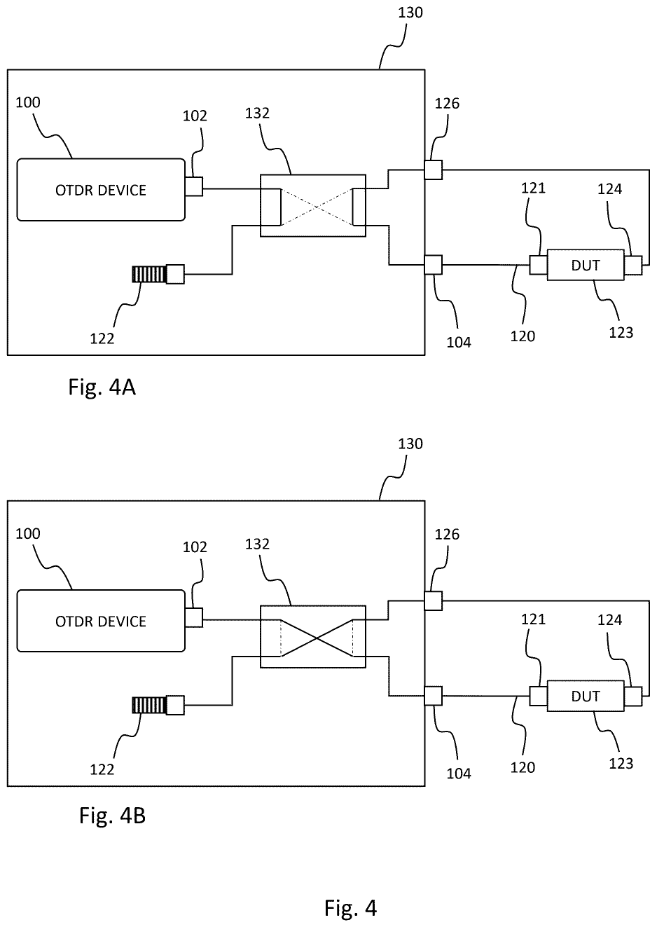

FIG. 4 illustrates another embodiment wherein the coupling device 111 and the reference reflector 122 are integrated directly into the OTDR test instrument 130. This embodiment differs from that of FIG. 3 in that it uses a bypass optical switch 132 to connect an internal reference reflector 122 to the DUT 123. The test instrument 130 comprises the bypass optical switch 132 connected between the OTDR device 100, the reference reflector 122, a first optical port 104 and a second optical port 126 of the test instrument. The DUT 123 is connected between the first optical port 104 and the second optical port 126. As shown in FIG. 4A, in the reference step, the bypass optical switch 132 is set so as to connect the output 102 of the OTDR device 100 to the reference reflector 122, thereby bypassing the DUT 123. As shown in FIG. 4B, in the DUT measurement step, the bypass optical switch 132 is then set to connect the output 102 of the OTDR device 100 towards the first optical port 104 and therefore towards the proximal end 121 of the DUT 123 while connecting the second optical port 126 and therefore the remote end 124 of the DUT 123 towards the reference reflector 122, such that the DUT 123 and the reference reflector 122 are connected in series.

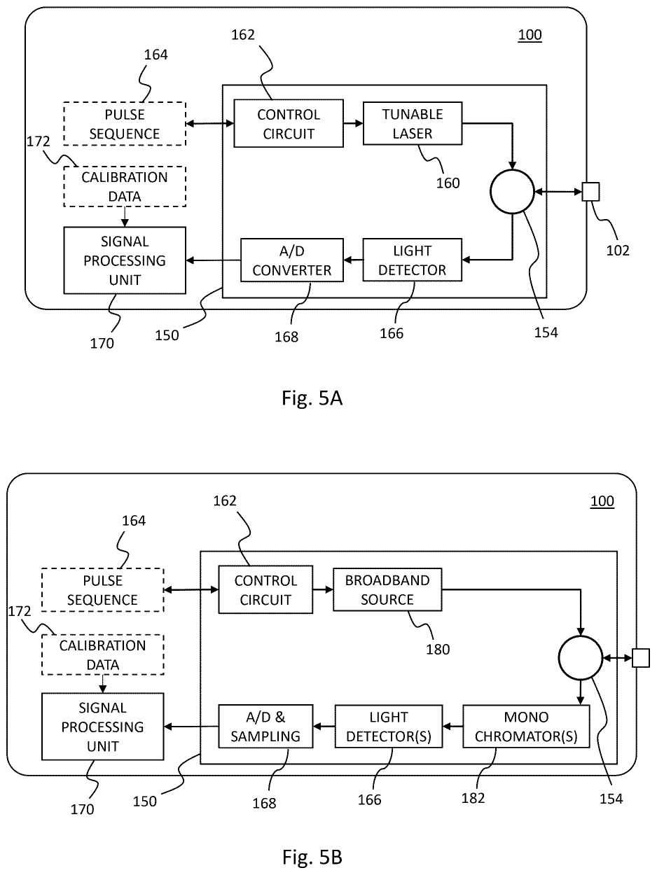

FIG. 5A illustrates a multi-wavelength OTDR device 100, in accordance with one embodiment. In the embodiment of FIG. 5A, OTDR acquisitions are obtained for varying wavelengths using a tunable pulsed laser source. An OTDR acquisition device 150 comprises the tunable laser source 160, a control circuit 162 to control the tunable laser source 160 to generate pulsed test signal in accordance with a given wavelength, pulse width, repetition rate, etc., an optional programmable pulse sequence 164 (as explained in more detail hereinbelow), a directional coupler or circulator 154 to launch the pulsed test signal toward an output port 102 for connection toward the DUT and direct the return light signal returning from the DUT via the output port 102 to a light detector 166, such as a photodiode, an avalanche photodiode (APD) or any other suitable photodetector, and an acquisition system 168 to sample the return light signal. The tunable laser source 160 is used to tune the wavelengths of the OTDR test signal in order to make a plurality of OTDR acquisitions at a corresponding plurality of mutually-different wavelengths. A signal processing unit 170 is then used to analyze the acquired OTDR traces to derive the spectral transmission response of the DUT using optional calibration data 172. For example, the spectral range and wavelength step may be fixed or defined by the user within the user interface of the measurement instrument. For example, a spectral range between 1250 nm and 1670 nm may be envisaged.

In some embodiments, the measurement may use a fast wavelength swept tunable laser to obtain a tuning speed of, e.g., 1 nm/s to 100 nm/s and wavelength step of, e.g., 1 pm to 100 pm.

FIG. 5B illustrates a multi-wavelength OTDR device 100 in accordance with another embodiment wherein OTDR acquisitions are obtained for varying wavelengths using a broadband light source 180 along with one or more monochromators 182 used to isolate discrete wavelengths. The embodiment of FIG. 5B is similar to that of FIG. 5A except that the tunable laser source 160 is replaced by the broadband light source 180 and monochromators 182. A broadband pulsed test signal is coupled to the DUT via the output port 120 and the returning broadband light is filtered using monochromator(s) 182 before detection. The monochromator(s) may be embodied, e.g., by a single-wavelength tunable monochromator or a wavelength division demultiplexer to generate return light signals at a plurality of mutually-different wavelengths to be then detected using a corresponding plurality of light detector(s).

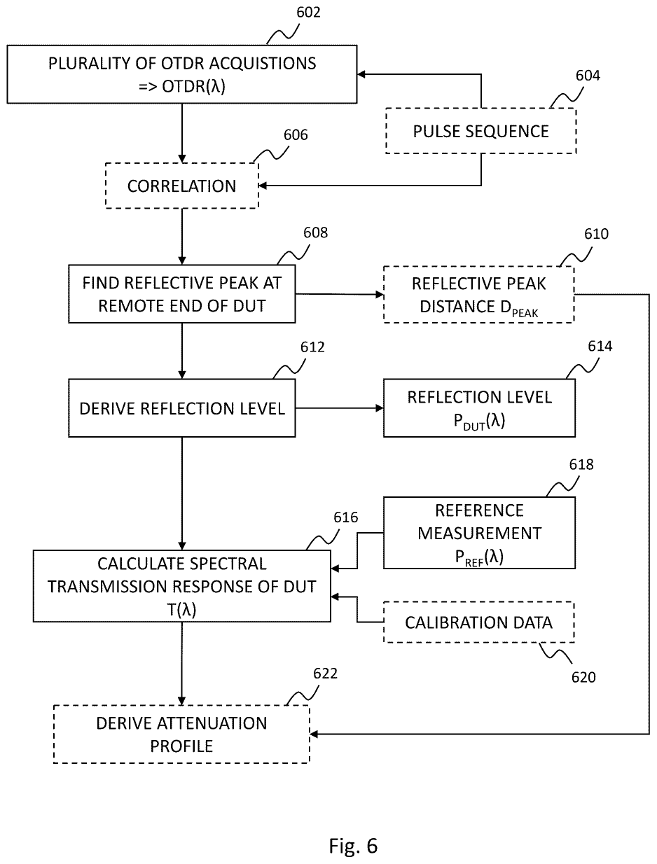

FIG. 6 illustrates a method for measuring the spectral transmission response T(λ) of a DUT in accordance with one embodiment. As explained with reference to FIGS. 1 and 2, the measurement requires the monitoring of a reflective surface located at the remote end of the DUT (for the DUT measurement step), as well as a reference reflector (for the reference step), which can be performed concurrently or in turn.

The DUT measurement step of the method comprises, in step 602, performing a plurality of OTDR acquisitions from a proximal end of the DUT for a corresponding plurality of mutually-different wavelengths while the DUT is connected to the OTDR device, e.g., as in FIG. 1B or FIG. 2 for example. Each OTDR acquisition is performed by propagating in the device under test, a pulsed test signal and detecting a corresponding return light signal from the device under test representing backscattered and reflected light as a function of distance in the device under test. Optionally, in some embodiments, a sequence of pulses is used instead of a more conventional OTDR measurement, the test signal then comprising a plurality of light pulses in accordance with a known pulse sequence 604 (as explained in more detail hereinbelow).

It is noted that the OTDR acquisitions may use varying measurement settings or measurement configurations. For example, the OTDR light pulses may have variable pulse widths such as, e.g., between 1 ns to 100 us.

Each of the plurality of OTDR acquisitions is then processed in order to obtain therefrom the spectral transmission response T(λ) of the DUT.

Optionally, in step 606, if a sequence of pulses is used, a correlation method is then used to detect the sequence of pulses after a back-reflection from the reflective surface at the remote end of the DUT. This process can be regarded as a cross-correlation of the acquired return signal with the known sequence of pulses used for the acquisition. It yields a processed repeated pulse trace from which the position of the reflective peak can be extracted in 608, e.g., as the position of the maximum correlation peak of the repeated pulse trace. It is noted that, in some embodiments, the cross-correlation may be calculated using an impulse pulse sequence corresponding to the sequence of pulse as described in U.S. patent application Ser. No. 18/933,474 filed Oct. 31, 2024, which is commonly owned by Applicant and the content of which hereby incorporated by reference.

Otherwise, in step 608, a conventional OTDR analysis method may be used to find a position of the reflective peak associated with the reflective surface at a remote end of the DUT. In step 610, the distance D_{PEAK} to the reflective device 125 at the remote end of the DUT may further be derived from the position of the reflective peak along the OTDR trace, for later use in calculating attenuation values.

It is noted that the position of the reflective peak D_{PEAK} is determined by the time of flight of light pulses from the OTDR device to the reflective device at the corresponding wavelength. The time of flight can then be related to the distance between the OTDR device and the reflective device as follows:

$$Distance = \frac{c \cdot t}{2 \cdot n ( λ )} \qquad ( 1 )$$

wherein c is the speed of light in vacuum, n(λ) is the index of refraction of the optical fiber, which depends on the wavelength at which the OTDR acquisition is performed, and t is the round-trip time of flight in the optical fiber. The division by 2 accounts for the round trip in the optical fiber from the OTDR device to the reflective device and back to the OTDR device.

In step 612, the reflection level P_{DUT(λ)} of the reflective peak associated with the reflective surface at a remote end of the DUT is extracted.

It is noted that from the acquired OTDR trace, signal processing may determine both the time of flight (related to the distance) of the reflective peak corresponding to the reflective surface, and its reflection level. The value of the reflection level of the reflective peak is found to yield a reflection measurement at the current wavelength. It is noted that the reflection level may be read by averaging values over the train of pulses on the acquired OTDR trace or on the peak of the cross-correlated trace, which methods are equivalent in terms of averaging.

This process is repeated for each wavelength within a predefined spectral range to reach, in 614, the reflection level P_{DUT(λ)} of the reflective peak as a function of wavelength.

Finally, in step 616, values of a spectral transmission response T(λ) associated with the DUT are extracted from the values of reflection level P_{DUT(λ)} of the reflective peak as a function of wavelength, in combination with a reference measurement P_{REF(λ)} associated with the reference reflector.

Assuming a test arrangement as per FIG. 1 or FIG. 2 where the reference reflector 122 is the same as the reflective device 125, the spectral transmission response T(λ) is derived as follows:

$$T ( λ ) = {P}_{DUT} ( λ ) / {P}_{REF} ( λ ) \qquad ( 2 )$$

In other embodiments and as described hereinbelow, the spectral transmission response T(λ) may optionally account for the difference in spectral reflection response between the reference reflector 122 and the reflective surface 125 via calibration data 620.

It is noted that the reference measurement P_{REF(λ)} of 618 can be obtained from a prior reference measurement step. The reference measurement step may be performed by conducting steps 602, 606, 608 and 612 on OTDR acquisitions obtained on the reference reflector 122 instead of the reflective surface 125 of the DUT, i.e. performing a plurality of OTDR acquisitions toward a reference reflector for the plurality of mutually-different wavelengths, extracting a value of a reflection level of the reference reflector for OTDR acquisition and obtaining values of the reference measurement P_{REF(λ)} from the values of reflection level of the reflective peak as a function of wavelength and optionally deriving the length of the reference device from the position of the reflective peak along the OTDR traces. These steps being otherwise similarly performed in the reference measurement step and will not be repeatedly described.

Optionally, in step 622, the attenuation profile Atten(λ) may be derived from the calculated spectral transmission response and DUT length, wherein the attenuation corresponds to the insertion loss per unit of length in an optical fiber DUT.

Assuming a test arrangement as per FIG. 1 or FIG. 2, both the reference measurement and the DUT measurement share the same reference cord 120 which is not part of the DUT per se. Accordingly, the length of the DUT may be derived from the position (D_{PEAK}, D_{REF}) of the reflective peak in the DUT and the reference measurements (in units of distance):

$${L}_{DUT} = {D}_{PEAK} - {D}_{REF} \qquad ( 3 )$$

and the attenuation of the DUT then be calculated as:

$$Atten ( λ ) = T ( λ ) / {L}_{DUT} \qquad ( 4 )$$

wherein D_{PEAK} corresponds to the distance between reflective device 125 and the OTDR device in the DUT measurement step and D_{REF} to the distance between reference reflector 122 and the OTDR device in the reference measurement step. Of course, the calculations may be adapted in case the reference measurement and the DUT measurement do not share the same reference cord 120 (such as in the case of reference reflector integrated as part of the OTDR device for example).

It is noted that in some embodiments, a single reference measurement can apply for a plurality of DUT measurements in order to save measurement time.

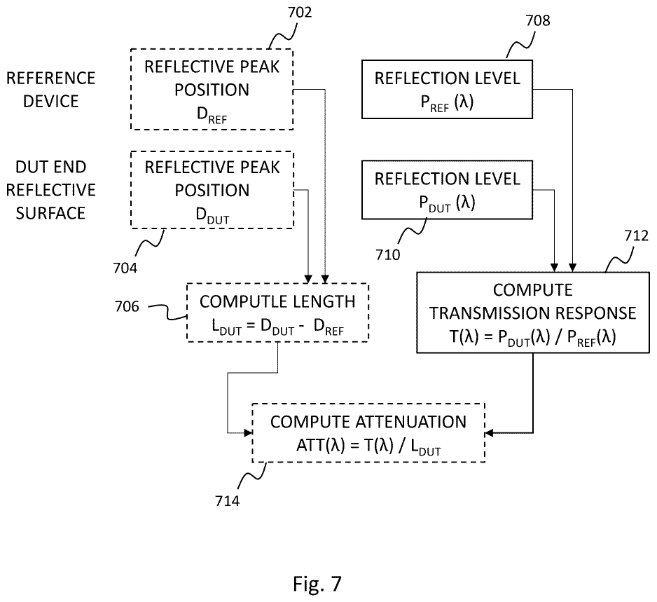

FIG. 7 illustrates steps 616 and 622 in more detail. In 706, the length L_{DUT} of the DUT is calculated from the position (D_{REF}, D_{PEAK}) of the reflective peak in the reference and the DUT measurements. In 712, the spectral transmission response T(λ) is calculated from the reflection level (P_{REF(λ)}, P_{DUT(λ)}) as a function of wavelength in the reference and the DUT measurements. And finally, in step 714, the attenuation profile is calculated from the spectral transmission response T(λ) and the length L_{DUT} of the DUT.

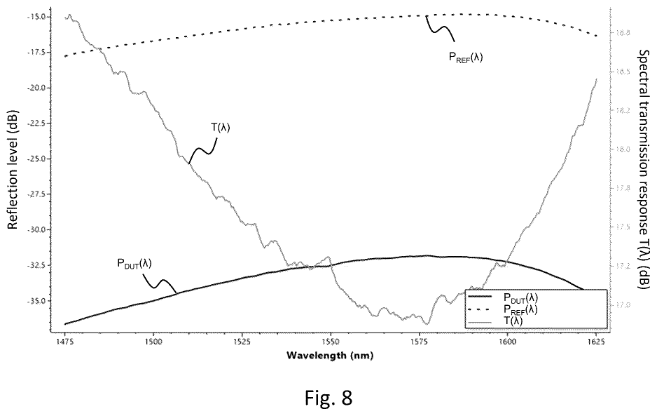

FIG. 8 shows exemplary measurement results as obtained on a DUT. It shows the reference measurement P_{REF(λ)}, the DUT measurement P_{DUT(λ)} and the resulting spectral transmission response T(λ) of an optical device under test.

### Calibration Data

In some embodiments, the reference reflector 122 and the reflective device 125 may be the exact same device that is connected as per FIG. 1A to perform the reference measurement step and then as per FIG. 1B to perform the DUT measurement step. In such cases, the spectral transmission response T(λ) may be derived directly from then reflection level P_{DUT(λ)} of the reflective peak and the reference measurement P_{REF(λ)} (see equation (2)). The same may also apply if the reference reflector 122 and the reflective device 125 are not the same device but are made of the same technology and known to have the same spectral reflection response by design (slight variations being considered negligible).

However, if the spectral reflection response of the reference reflector 122 and the reflective device 125 cannot be expected to be the same, the difference in their spectral reflection responses should be known and accounted for in the calculations in order for the measurement to be the most accurate. In some embodiments, calculating the spectral transmission response may account for the spectral reflection response SR_{P125(λ)} of the reflective surface 125 and the spectral reflection response SR_{122(λ)} of the reference reflector 122 or at least a presumed or known relation between them. Given the known or presumed relation between the spectral reflection response SR_{125(λ)} of the reflective surface 125 actually being used in practice and the spectral reflection response SR_{122(λ)} of the reference reflector 122, a compensation function COMP(λ) may be obtained as:

$$COMP ( λ ) = \frac{SR 125 ( λ )}{SR 122 ( λ )} \qquad ( 5 )$$

which can be used to correct the measurement as:

$$T ( λ ) = \frac{1}{COMP ( λ )} \cdot \frac{{P}_{DUT} ( λ )}{{P}_{REF} ( λ )} \qquad ( 6 )$$

The spectral reflection responses of the reference reflector 122 and the reflective surface 125 may be determined by measurement in a separate calibration process (such as a factory calibration) which yields the calibration data 172 or may otherwise be known by design.

In yet another embodiment, the reference step may be performed previously, e.g., in factory, to obtain a reference measurement P_{REF(λ)} corresponding to the reference reflector 122.

### Pulse Sequence

It is noted that, in some embodiments, each OTDR acquisition is performed in a conventional manner wherein a single OTDR light pulse is launched at a time, waiting for its return from the end of the POD to launch the next OTDR light pulse.

However, in some other embodiments, the dynamic range/acquisition time of the measurement may be improved using a technique similar to correlation coded OTDR. In short, for each OTDR acquisition, instead of launching a single OTDR pulse at a time, a sequence of pulses is used (also referred to herein as a pulse train) such that the plurality of light pulses of a sequence of pulses are together propagated in the DUT within a round-trip time within the DUT. A correlation method is then used to detect the sequence of pulses after a back-reflection from a reflective event at the remote end of the DUT, and extract the position and the reflection level of the reflective peak. The sequence of pulses may take the form of a train of pulses comprising a plurality of light pulses, such as between 2 and 1000, or an encoded sequence of pulses. For example, in one embodiment, the pulsed test signal may comprise, e.g., a train of 10 to 100 pulses with a pulse period of 0.1 to 10 μs.

In some embodiments, the pulse period and the time delay between any two consecutive pulses are the same for all pulses but, in other embodiments, the pulse period and/or time delay may vary from pulse to pulse.

Different types of pulse sequences may be considered such as, e.g., a repeated pulse sequence or a binary coded sequence. More specifically, the sequence of pulses of the pulsed test signal may comprise a binary coded sequence of pulses (such as a pseudorandom pulse sequences or Golay-coded pulse sequences), or a periodic equidistant repeated pulse sequence (pulse train), a chirped sequence of pulses or any other pulse coded sequence. It is noted that the periodic equidistant repeated pulse sequence represents a special case of the binary sequence in which the binary code is a series of ‘1’. A sequence of pulses is defined by a binary code sequence, a pulse length and a pulse repetition period. The sequence may be made programmable in length, and in its binary code.

More details on the pulse sequence approach may be found in U.S. patent application Ser. No. 18/933,474 filed Oct. 31, 2024, which is commonly owned by Applicant and the content of which hereby incorporated by reference.

Other approaches of coded OTDR have been proposed in the literature (such as, e.g., the Simplex method, see Jones, “Using simplex codes to improve OTDR sensitivity,” IEEE Photonics Technol. Lett. 5(7), 822-824(1993), Nazarathy et al., “Real-time long range complementary correlation optical time domain reflectometer,” J. Lightwave Technol. 7(1), 24-38 (1989) and Sischka et al., “Complementary Correlation Optical Time-Domain Reflectometry”, December 1988 HEWLETT-PACKARD JOURNAL). These techniques may be adapted to detect the remote reflective peak in the context of the methods proposed herein.

It is noted that the use of a sequence of pulses instead of a single pulse has the benefit of improving the dynamic range but the downside of increasing the level of Rayleigh backscattering (RBS). It is noted that the reflected signal is a superposition of RBS and discrete reflections. Care should therefore be taken to select a number of pulses and a pulse width which maximize the dynamic range of the measurement, while still maintaining the level of RBS to an acceptable limit so that it does not hide the reflection peak of the reference reflector and the reference device. For example and without limitation, in order to facilitate measurements, the number of pulses may be selected so that the RBS level remains significantly lower than the reflection level, such as, e.g.:

$$RBS < 0.1 * R$$

wherein RBS corresponds to the Rayleigh backscattering level from the reference fiber 120, and R to the reflectance level at the reference reflector 122.

Accordingly, the reference reflector 122 and the reflective device 125 may advantageously generate a reflection that is substantially higher than the level of the RBS which comes back from the optical fiber, such that the RBS level becomes negligible. Otherwise, the RBS level may be measured and subtracted from the reflection level so as to improve the measurement accuracy.

In any case, one OTDR acquisition may involve performing multiple acquisitions and averaging the results.

### Example of OTDR Device Architecture

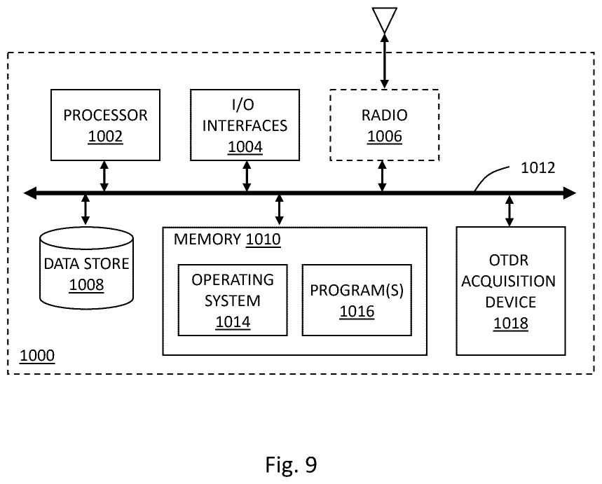

FIG. 9 is a block diagram of an OTDR device 1000 which may embody the OTDR device 100 of FIG. 3. The OTDR device 1000 may comprise a digital device that, in terms of hardware architecture, generally includes a processor 1002, input/output (I/O) interfaces 1004, an optional radio 1006, a data store 1008, a memory 1010, as well as an optical test device including an OTDR acquisition device 1018. It should be appreciated by those of ordinary skill in the art that FIG. 9 depicts the OTDR device 1000 in a simplified manner, and a practical embodiment may include additional components and suitably configured processing logic to support known or conventional operating features that are not described in detail herein. A local interface 1012 interconnects the major components. The local interface 1012 can be, for example, but not limited to, one or more buses or other wired or wireless connections, as is known in the art. The local interface 1012 can have additional elements, which are omitted for simplicity, such as controllers, buffers (caches), drivers, repeaters, and receivers, among many others, to enable communications. Further, the local interface 1012 may include address, control, and/or data connections to enable appropriate communications among the aforementioned components.

The processor 1002 is a hardware device for executing software instructions. The processor 1002 may comprise one or more processors, including central processing units (CPU), auxiliary processor(s) or generally any device for executing software instructions. When the OTDR device 1000 is in operation, the processor 1002 is configured to execute software stored within the memory 1010, to communicate data to and from the memory 1010, and to generally control operations of the OTDR device 1000 pursuant to the software instructions. In an embodiment, the processor 1002 may include an optimized mobile processor such as optimized for power consumption and mobile applications. The I/O interfaces 1004 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like, via one or more LEDs or a set of LEDs, or via one or more buzzer or beepers, etc. The I/O interfaces 1004 can be used to display a graphical user interface (GUI) that enables a user to interact with the OTDR device 1000 and/or output at least one of the values derived by the OTDR analyzing module.

The radio 1006, if included, may enable wireless communication to an external access device or network. Any number of suitable wireless data communication protocols, techniques, or methodologies can be supported by the radio 1006, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); NarrowBand Internet of Things (NB-IoT); Long Term Evolution Machine Type Communication (LTE-M); magnetic induction; satellite data communication protocols; and any other protocols for wireless communication. The data store 1008 may be used to store data, such as OTDR traces and OTDR measurement data files. The data store 1008 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 1008 may incorporate electronic, magnetic, optical, and/or other types of storage media.

The memory 1010 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 1010 may incorporate electronic, magnetic, optical, and/or other types of storage media. Note that the memory 1010 may have a distributed architecture, where various components are situated remotely from one another, but can be accessed by the processor 1002. The software in memory 1010 can include one or more computer programs, each of which includes an ordered listing of executable instructions for implementing logical functions. In the example of FIG. 9, the software in the memory 1010 includes a suitable operating system (O/S) 1014 and computer programs 1016. The operating system 1014 essentially controls the execution of other computer programs and provides scheduling, input-output control, file and data management, memory management, and communication control and related services. The program(s) 1016 may include various applications, add-ons, etc. configured to provide end-user functionality with the OTDR device 1000. For example, programs 1016 may include a web browser to connect with a server for transferring OTDR measurement data files, a dedicated OTDR application configured to control OTDR acquisitions by the OTDR acquisition device 1018, set OTDR acquisition parameters, analyze OTDR traces obtained by the OTDR acquisition device 1018 and display a GUI related to the OTDR device 1000. For example, the dedicated OTDR application may embody an OTDR analysis module configured to analyze acquired OTDR traces in order to characterize the device under test, and produce OTDR measurement data files.

It is noted that, in some embodiments, the I/O interfaces 1004 may be provided via a physically distinct mobile device (not shown), such as a handheld computer, a smartphone, a tablet computer, a laptop computer, a wearable computer or the like, e.g., communicatively coupled to the OTDR device 1000 via the radio 1006. In such cases, at least some of the programs 1016 may be located in a memory of such a mobile device, for execution by a processor of the physically distinct device. The mobile device may then also include a radio and be used to transfer OTDR measurement data files toward a remote test application residing, e.g., on a server.

It should be noted that the OTDR device shown in FIG. 9 is meant as an illustrative example only. Numerous types of computer systems are available and can be used to implement the OTDR device.

### Example of OTDR Acquisition Device Architecture

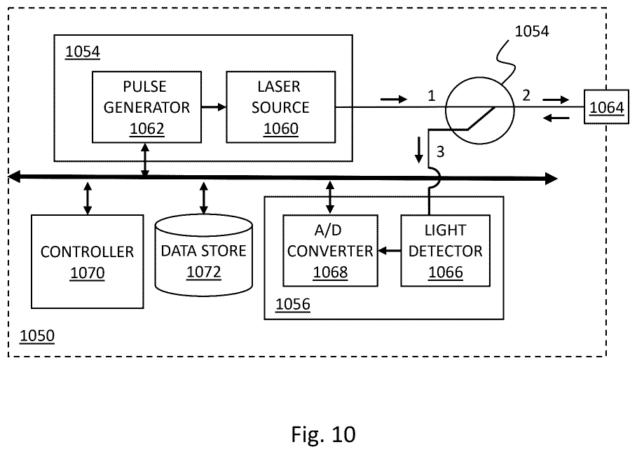

FIG. 10 is a block diagram an embodiment of an OTDR acquisition device 1050 which may embody the OTDR acquisition device 1018 of the OTDR device 1000 of FIG. 9.

The OTDR acquisition device 1050 is connectable toward the device under test via an output interface 1064, for performing OTDR acquisitions toward the device under test. The OTDR acquisition device 1050 comprises conventional optical hardware and electronics as known in the art for performing OTDR acquisitions over a device under test.

The OTDR acquisition device 1050 comprises a light generating assembly 1054, a detection assembly 1056, a directional coupler 1058, as well as a controller 1070 and a data store 1072.

The light generating assembly 1054 is embodied by a laser source 1060 driven by a pulse generator 1062 to generate the OTDR test signal comprising test light pulses having desired characteristics. As known in the art, the light generating assembly 1054 is adapted to generate test light pulses of varied pulse widths, repetition periods and optical power through a proper control of the pattern produced by the pulse generator 1062. One skilled in the art will understand that it may be beneficial or required by the application to perform OTDR measurements at various different wavelengths. For this purpose, in some embodiments, the light generating assembly 1054 is adapted to generate test light pulses having varied wavelengths by employing a laser source 1060 that is tunable for example. It will be understood that the light generating assembly 1054 may combine both pulse width and wavelength control capabilities. Of course, different and/or additional components may be provided in the light generating assembly, such as modulators, lenses, mirrors, optical filters, wavelength selectors and the like.

The light generating assembly 1054 is coupled to the output interface 1064 of the OTDR acquisition device 1050 through a directional coupler 1058, such as a circulator, having three or more ports. The first port is connected to the light generating assembly 1054 to receive the test light pulses therefrom. The second port is connected toward the output interface 1064. The third port is connected to the detection assembly 1056. The connections are such that test light pulses generated by the light generating assembly 1054 are coupled to the output interface 1064 and that the return light signal arising from backscattering and reflections along the device under test 110 is coupled to the detection assembly 1056.

The detection assembly 1056 comprises a light detector 1066, such as a photodiode, an avalanche photodiode or any other suitable photodetector, which detects the return light signal corresponding to each test light pulse, and an analog to digital converter 1068 to convert the electrical signal proportional to the detected return light signal from analog to digital in order to allow data storage and processing. It will be understood that the detected return light signal may of course be amplified, filtered or otherwise processed before or after analog to digital conversion. The power level of return light signal as a function of time, which is obtained from the detection and conversion above, is referred to as one acquisition of an OTDR trace. One skilled in the art will readily understand that in the context of OTDR methods and systems, each light acquisition generally involves propagating a large number of substantially identical light pulses in the device under test and averaging the results, in order to improve the Signal-to-Noise Ratio (SNR). In this case, the result obtained from averaging is herein referred to as an OTDR trace.

Of course, the OTDR acquisition device 1050 may also be used to perform multiple acquisitions with varied pulse widths to obtain a multi-pulsewidth OTDR measurement.

The OTDR acquisition device 1050, and more specifically the light generating assembly 1054 is controlled by the controller 1070. The controller 1070 is a hardware logic device. It may comprise one or more Field Programmable Gate Array (FPGA); one or more Application Specific Integrated Circuits (ASICs) or one or more processors, configured with a logic state machine or stored program instructions. When the OTDR acquisition device 1050 is in operation, the controller 1070 is configured to control the OTDR measurement process. The controller 1070 controls parameters of the light generating assembly 1054 according to OTDR acquisition parameters that are either provided by the operator of the OTDR software or otherwise determined by program(s) 1016.

The data store 1072 may be used to cumulate raw data received from the detection assembly 1056, as well as intermediary averaged results and resulting OTDR traces. The data store 1008 may include any of volatile memory elements (e.g., random access memory (RAM, such as DRAM, SRAM, SDRAM, and the like)) or the like and it may be embedded with the controller 1070 or distinct.

The OTDR traces acquired by the OTDR acquisition device 1050 may be received and analyzed by one or more of the computer programs 1016 and/or stored in data store 1008 for further processing.

It should be noted that the architecture of the OTDR acquisition device 1050 as shown in FIG. 10 is meant as an illustrative example only. Numerous types of optical and electronic components are available and can be used to implement the OTDR acquisition device.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to specific embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

The embodiments described above are intended to be exemplary only and one skilled in the art will recognize that numerous modifications can be made to these embodiments without departing from the scope of the invention. The scope of the invention is therefore intended to be limited solely by the appended claims.

1. A method for measuring the spectral transmission response of an optical device under test, the method comprising:
performing a plurality of OTDR acquisitions from a proximal end of the device under test for a corresponding plurality of mutually-different wavelengths, wherein each OTDR acquisition is performed by propagating in the device under test, a pulsed test signal and detecting a corresponding return light signal from the device under test representing backscattered and reflected light as a function of distance in the device under test;
for each of the OTDR acquisitions, extracting a value of a reflection level of a reflective peak associated with a reflective surface at a remote end of the optical device under test; and
calculating values of a spectral transmission response associated with said device from the values of reflection level of the reflective peak as a function of said wavelengths, in combination with a reference measurement associated with a reference reflector.

2. The method as claimed in claim 1, wherein said performing a plurality of OTDR acquisitions comprises tuning said pulsed test signal across a spectral range of interest to obtain each of said corresponding plurality of mutually-different wavelengths.

3. The method as claimed in claim 1, wherein said test signal comprises a plurality of light pulses in accordance with a known sequence of pulses.

4. The method as claimed in claim 3, wherein said value of reflection level of the reflective peak is obtained by calculating a cross-correlation between the known sequence of pulses and the acquired return signal.

5. The method as claimed in claim 1, wherein said reflective surface comprises a highly reflective device connected to the remote end of the device under test.

6. The method as claimed in claim 5, wherein said highly reflective device comprises an opened non-angled polished connector at the remote end of the device under test.

7. The method as claimed in claim 1, wherein said reflective surface comprises a reflective surface part of the device under test.

8. The method as claimed in claim 1, further comprising:
performing a plurality of OTDR acquisitions toward a reference reflector for said plurality of mutually-different wavelengths, wherein each OTDR acquisition is performed by propagating toward the reference reflector, a pulsed test signal and detecting a corresponding return light signal from the device under test;
for each of said OTDR acquisitions, extracting a value of a reflection level of the reference reflector;
obtaining values of said reference measurement from the values of reflection level of the reflective peak as a function of said wavelengths.

9. The method as claimed in claim 8, wherein the steps of performing OTDR acquisitions from a proximal end of the device under test and performing OTDR acquisitions toward a reference reflector are performed concurrently.

10. The method as claimed in claim 8, wherein said calculating values of a spectral transmission response accounts for a spectral reflection response of said reflective surface and a spectral reflection response of said reference reflector.

11. A test system for measuring the spectral transmission response of an optical device under test, the OTDR system comprising:
an OTDR acquisition device connectable toward a proximal end of the device under test for performing a plurality of OTDR acquisitions for a corresponding plurality of mutually-different wavelengths, wherein each OTDR acquisition is performed by propagating in the device under test, a pulsed test signal and detecting a corresponding return light signal from the device under test representing backscattered and reflected light as a function of distance in the device under test,
a reference device connectable to said OTDR acquisition device for performing a plurality of OTDR acquisitions toward said reference device, to obtain therefrom a reference measurement as a function of wavelengths across the spectral range of interest; and
a processing unit receiving the plurality of OTDR acquisitions and configured for:
from the plurality of OTDR acquisitions, extracting values of a reflection level of a reflective peak associated with a reflective surface at a remote end of the optical device under test;
from the plurality of OTDR acquisitions, extracting values of said reference measurement as a function of wavelengths; and
calculating values of a spectral transmission response associated with said device from the values of reflection level of the reflective peak as a function of said wavelengths, in combination with the reference measurement associated with the reference device.

12. The test system as claimed in claim 11, wherein said OTDR acquisition device comprises a tunable pulsed light source to perform said plurality of OTDR acquisitions at mutually-different wavelengths across a spectral range of interest.

13. The test system as claimed in claim 11, further comprising a coupling device connected to direct the pulsed test signal toward the reference device and the device under test either concurrently or in turn.

14. The test system as claimed in claim 13, wherein the coupling device comprises a power coupler to direct the pulsed test signal toward the reference device and the device under test concurrently.

15. The test system as claimed in claim 13, wherein the coupling device comprises an optical switch to direct the pulsed test signal toward the reference device or the device under test, in turn.

16. The test system as claimed in claim 13, wherein the coupling device comprises a bypass optical switch to direct the pulsed test signal toward the reference device or the device under test in series with the reference device, in turn.

17. The test system as claimed in claim 11, wherein said test signal comprises a plurality of light pulses in accordance with a known sequence of pulses.

18. The test system as claimed in claim 11, wherein said reflective surface comprises a highly reflective device connected to the remote end of the device under test.

19. The test system as claimed in claim 18, wherein said highly reflective device comprises an opened non-angled polished connector at the remote end of the device under test.

20. The test system as claimed in claim 11, wherein said reflective surface comprises a reflective surface part of the device under test.
